(19) United States
(12) Patent Application Publication
(10) Pub. No.: US 2015/0206242 A1
(43) Pub. Date: Jul. 23, 2015

(54) BASEBALL TERMINOLOGY CONNECTED INVESTMENT EVALUATION AND CHARACTERISTIC ANALYSIS METHOD AND SYSTEM THEREFOR

(71) Applicant: Yonung-Joo O., Seoul (KR)

(72) Inventor: Young-Joo O, Seoul (KR)

(21) Appl. No.: 14/413,895

(22) PCT Filed: Jul. 9, 2013
(86) PCT No.: PCT/KR2013/006090

§ 371 Date: Jan. 9, 2015

(30) Foreign Application Priority Data
Jul. 10, 2012 (KR) 10-2012-0074939

(51) Int. Cl. G06Q 40/06

(52) U.S. Cl. CPC G06Q 40/06

(57) ABSTRACT

Provided is a system and method thereof for each investor to easily understand his investment pattern using characteristics of baseball terms by patterning profits and losses of possessed items in trade of stocks or fluctuation of an account balance and associating the patterns with baseball terms to connectively express them and more particularly, to a method and a system thereof for a stock investor to easily analyze and understand his own dealing pattern and to cope with it through a system associating market price information of possessed items or fluctuation of an account balance with terms of similar patterns and concept in terms used in baseball.

### BACKGROUND

The present invention relates to a system and a method thereof for each investor to easily understand his investment pattern using characteristics of baseball terms by patterning profits and losses of possessed items in trade of stocks or fluctuation of an account balance and associating the patterns with baseball terms to connectively express them and more particularly, to a method and a system thereof for a stock investor to easily analyze and understand his own dealing pattern and to cope with it through a system associating market price information of possessed items or fluctuation of an account balance with terms of similar patterns and concept in terms used in baseball.

Recently, according to the advance of PC, various programs and online communication networks, cyber trading using online has been generalized, and the cyber trading using online in trade of bonds and currency as well as trade of stocks, futures, and options has advantages such as easy accessibility, providing of various kinds information, real-time grasping of market price and rapid dealing order.

According to such a trend, in addition to professional investors, general people easily go into investment of stocks and the like, people who have to make a decision at the time of investment do not have professionalism as much as wanting separate investment training, and make a dealing decision using only the oldest information transferred by various media as information referred to investment, as a result, most of them experience investment loss, therefore, more effective stock dealing analysis is necessary.

In addition, as compared with large investment institutes or professional analysts, personal investors are placed in a serious asymmetrical situation of information, it is difficult for the personal investors to have professional ability which can rightly analyze information even if the same information is given to the personal investors, and finally, the personal investors use the information opened through financial institutions or news media for basic analysis in spite of disadvantages, and depend on technical analysis as a tool for establishing and using their investment standard, which is a general phenomenon.

The technical analysis is based on analysis of a chart and the like on the assumption that all information is reflected to change in stock price, is a method of analyzing past and current flow of stock prices and trading volume to predict future stock prices, and is a method of finding a trend of change in stock price using data such as past stock prices or trading volume to predict future stock prices as a traditional stock analysis method. In a case of such technical analysis, the analysis is very difficult and complicated, it is not easy for stock beginners to access it, and a lot of time is necessary to analyze overall characteristics of items of listed companies more than 2,000. In addition, in the technical analysis, investors have to accurately understand and utilize various kinds of charts such as a candle chart, a bar chart, a comparison chart, a sale band chart, a flow chart, and an Ichimoku chart, and about 300 indicators, hundreds of thousands of charts are made when they are combined, and thus there is a problem of needing a lot of studies and real experience in investors.

Also in a case of full-time investors who professionally invest in stocks, it is impossible to analyze all items more than 2,000 in detail for a short time while changing variables of the indicators, 20 days or more are required to see the entire of KOSPI and KOSDAQ if 100 graphs are analyzed in a day, and a time of a few years is required to analyze graphs such as monthly fluctuation (monthly candles), weekly fluctuation (weekly candles), daily fluctuation (daily candles), 60-min candles, 30-min candles, 15-min candles, 10-min candles, and 5-min candles. A great number of indicators are added herein for analysis, and investors have to see new charts every hour and every minute.

Such difficulties of analysis access make also professional investors spend most of daily time investing in stock analysis, make stock beginners need a few years to establish their own investment method and lose a lot of investments, and causes investors, who do not establish such an investment method, to fail in stock investment in a few months to a few years. This makes investors have aversion about stock analysis and play a role in making them recognize stocks as merely gambling and access thereto. Accordingly, it is a time point of requiring means for allowing general investors to easily understand characteristics of stocks and to statically access them.

In order to solve such a problem, the present applicant invented a system to analyze items using substitution terms which the general investors can easily understand, particularly, baseball terms. This system analyzes items themselves through baseball terms, and has an excellent effect to easily understand characteristics of items, but, fundamentally prior to it, cannot analyze an investment style based on interest or propensity of investors themselves, dealing pattern, and success and failure cases.

That is, it is very troublesome for general investors to analyze a dealing result in detail after dealing stocks, the general investors have insufficient analysis ability to find and analyze the highest-return dealing and have restriction of time, and the analysis itself is technically very difficult and hard. In addition, there are many cases where general stock dealers do not deeply consider their dealings or balance returns.

Characteristic analysis of stock items is important, but dealing pattern analysis of stock investors is also important. For example, the dealing pattern of the most beginning stock investor has a tendency of impatiently selling possessed stocks when the possessed stocks rises a little, and has a tendency of further increasing a loss by continuous possession or stock watering when the possessed stocks start falling. Such a part is a reason why dealing pattern analysis of stock investors is important. In addition, characteristics of individual stock items are different from each other, investment dealing patterns or propensities of stock investors cannot help being different from each other, and it is obvious that possibility of high returns is high when characteristics of movement of any item significantly coincide with the dealing pattern of a stock dealer if returns are maximized in any dealing of the item.

In addition to item analysis enough to invest, necessity for a system and a method rises to check and analyze investor's own unique dealing style or pattern while utilizing terms which general investors can easily understand and traditionally necessary statistical factors.

In addition, means for statistically checking and defining what characteristics are in his successful dealing and what faults are in his unsuccessful dealing is necessary.

### SUMMARY OF INVENTION

The present invention has been made to solve the problem described above, and an object thereof is for a stock investor to understand his dealing status and investment pattern and characteristics through familiar baseball terms, through a system and a method of associating changes in possessed items and his account balance with baseball terms with a similar concept.

In addition, another object of the invention is to provide a system and a method of setting an easily understandable and effective dealing pattern by associating market prices of possessed items or the account balance with baseball term pattern having statistic efficiency accumulated by experience for a long time.

In addition, still another object of the invention is to provide a system and a method of easily analyzing and grasping his investment characteristic through characteristic associated by baseball terms and reflecting it to next investment to be improved.

In addition, still another object of the invention is to provide a stock investment decision indicator providing a precise and scientific analysis method by analyzing his own unique investment style or pattern for a short time and objectively resolving an abstract idea which has been known only by feeling and experience on the basis of characteristic statistics of each pattern.

In addition, still another object of the invention is to raise returns through investor's own dealing result analysis, and to extract, analyze, and pattern a dealing pattern of the highest returns through baseball terms through the entire dealing result or analysis for a predetermined period by objectively analyzing his problem.

A configuration of the invention to achieve the objects described above is to provide a baseball terminology connected investment evaluation and characteristic analysis method including: (1) an information reception step of receiving, by an information reception unit of a user terminal, evaluation information including market price information through a communication network; (2) an information extraction step of outputting, by an information extraction unit, determination information partially extracted from the evaluation information received by the information reception unit or derived by operating; (3) a classification association step of determining and associating, by a classification association unit, a class of the determination information in preset classification information; and (4) an output step of outputting, by an output unit, a result associated by the classification association unit.

The method further includes a process of storing, by a term definition unit, the classification information and a term corresponding to the classification information, loading, by the classification association unit, the classification information and the corresponding term stored in the term definition unit, classifying the determination information received from the information extraction unit according to the classification information, and associating the information with the corresponding term.

The corresponding term is a baseball term, and the classification association unit classifies the determination information according to the classification information, and associates the information with the baseball term.

In the output step, a possessed item or dealing pattern thereof is associated with the baseball term to be determined, by converting and outputting the market price change of the possessed item into the baseball term.

In the output step, changes in profits and losses of investments or dealing pattern thereof is associated with the baseball term to be determined, by converting and outputting the account balance change into the baseball term.

In addition, there is provided a baseball terminology connected investment evaluation and characteristic analysis system comprising: an information reception unit that receives evaluation information including market price information through a communication network; an information extraction unit that outputs determination information partially extracted from the evaluation information received by the information reception unit or derived by operating; a classification association unit that determines and associates a class of the determination information in preset classification information; and an output unit that outputs a result associated by the classification association unit.

The system further includes a term definition unit that stores the classification information and a term corresponding to the classification information, wherein the classification association unit loads the classification information and the corresponding term stored in the term definition unit, classifies the determination information received from the information extraction unit according to the classification information, and associates the information with the corresponding term.

The corresponding term is a baseball term, and the classification association unit classifies the determination information according to the classification information, and associates the information with the baseball term.

The determination information is information of change of a possessed item stock price or change of an account balance, the classification information is a rising range, the baseball term is a hit, and the classification association unit associates a case with the hit of the baseball term when the change of the stock price rises in the rising range according to the classification information or the change of the account balance rises in the rising range according to the classification information.

The determination information is information of a change rate of a possessed item stock price or a change rate of an account balance, the classification information is a price limit rising rate range or a specific range, the baseball term is a home run, and the classification association unit associates a case with the home run of the baseball term when the change rate of the possessed item stock price rises up to the price limit according to the classification information or the change of the account balance rises equal to or higher than the rising rate range according to the classification information.

The determination information is information of a change rate of a possessed item stock price or a change rate of an account balance, the classification information is a part of a rising rate range, the baseball term is an n-base hit (n is one of 1 to 3), and the classification association unit associates a case with the n-base hit of the baseball term when the change rate of the possessed item stock price rises in a partial specific range of the rising rate range according to the classification information or the change of the account balance rises in a partial specific range of the rising rate range according to the classification information.

The determination information is information of a change rate of a possessed item stock price or a change rate of an account balance, the classification information is a value obtained by dividing the number of rising days of the possessed item stock price for predetermined trading days by the number of possessing days or by dividing the rising days of the account balance by the number of possessing or trading days, the baseball term is a batting average, and the classification association unit associates the information with the batting average of the baseball term according to the classification information.

The determination information is information of a change rate of a possessed item stock price or a change rate of an account balance, the classification information is stock price rising rates at a predetermined trading day or a sum thereof or account balance rising rates or a sum thereof at a predetermined trading day, the baseball term is a run, and the classification association unit associates the information with the run of the baseball term according to the classification information.

The determination information is information of a change rate of a possessed item stock price or a change rate of an account balance, the classification information is a value obtained by dividing a sum of stock price rising rates at a predetermined trading day or a sum of account balance rising rates at a predetermined trading day by the number of rising possessing days or the number of rising dealing days, the baseball term is a run average, and the classification association unit associates the information with the run average of the baseball term according to the classification information.

The determination information is information of a change rate of a possessed item stock price or a change rate of an account balance, the classification information is rising and falling rate ranges, the baseball term is a bunt, and the classification association unit associates a case with the bunt of the baseball term when the change rate of the possessed item stock price or the change rate of the account balance was lower than no change at the opening price but rises higher than no change at the closing price according to the classification information.

The determination information is information of a change rate of a possessed item stock price or a change rate of an account balance, the classification information is rising and falling rate ranges, the baseball term is a failed bunt, and the classification association unit associates a case with the failed bunt of the baseball term when the change rate of the possessed item stock price or the change rate of the account balance was higher than no change at the opening price but falls lower than no change at the closing price according to the classification information.

The determination information is information of a change rate of a possessed item stock price or a change rate of an account balance, the classification information is two ranges of a part of a rising rate range, the baseball term is a steal, and the classification association unit associates a case with the steal of the baseball term when the change rate of the possessed item stock price is in a first range at an opening price rising rate and in a second range at a closing price rising rate according to the classification information or the change rate of the account balance is in a first range at the opening price rising rate and rises up to a second range at the closing price rising rate according to the classification information.

The determination information is information of a change rate of a possessed item stock price or a change rate of an account balance, the classification information is a part of a rising rate range, the baseball term is a home steal, and the classification association unit associates a case with the home steal of the baseball term when the change rate of the possessed item stock price is in a first range at an opening price rising rate and rises up to the price limit at a closing price rising rate according to the classification information or the change rate of the account balance is in a first range at the opening price rising rate and rises up to a second range at the closing price rising rate according to the classification information.

The determination information is information of a change rate of a possessed item stock price or a change rate of an account balance, the baseball term is an n-base hit (n is one of 1 to 3) when the classification information is a part of a rising rate range, the baseball term is a home run when the classification information is in a price limit rising range or is equal to or higher than a specific rising rate, and the classification association unit associates a case with the n-base hit when the change rate of the stock price rises in a partial specific range of a rising rate range according to the classification information or when the change rate of the account balance rises in a partial specific range of a rising rate range according to the classification information, associates a case with the home run when the change rate of the stock price rises up to the price limit according to the classification information or when the change rate of the account balance is equal to or higher than a specific rising rate, and associates a value obtained by summing products of weight values corresponding to the n-base hit and the home run and then dividing the sum by the number of possessing days or the number of dealing days, with a slugging average of the baseball term.

The classification association unit associates a value obtained by dividing the number of hit days by the number of possessing days or the number of dealing days with an on-base percentage of the baseball term.

The classification association unit associates the number of days corresponding to consecutive hits accumulated backward from the latest day for predetermined trading days with a consecutive hit of the baseball term.

The classification association unit associates the number of days corresponding to consecutive home runs accumulated backward from the latest day for predetermined trading days with a consecutive home run of the baseball term.

The classification association unit associates a value obtained by dividing the number of days when the stock price of the possessed item belongs to a partial specific range of a rising rate range and then a closing price corresponds to the home run by the number of possessing days when the stock price belongs to the specific range, with a scoring position batting average of the baseball term, or associates a value obtained by dividing the number of days when the account balance belongs to a partial specific range of a rising rate range and then a closing price corresponds to the home run by the number of trading days when the account balance belongs to the specific range, with a scoring position batting average of the baseball term.

The determination information is information of a change rate of a possessed item stock price or a change rate of an account balance, the classification information is a falling range, the baseball term is an out, and the classification association unit associates a case with the out of the baseball term when the change of the stock price or the change of the account balance falls in the falling range according to the classification information.

The determination information is information of a change rate of a possessed item stock price or a change rate of an account balance, the classification information is a part of a falling rate range, the baseball term is a strikeout, a double play, or a triple play, and the classification association unit associates a case with the strikeout, the double play, or the triple play of the baseball term when the change rate of the stock price or the change rate of the account balance falls in a partial specific range of a falling rate range according to the classification information.

The determination information is information of a change rate of a possessed item stock price or a change rate of an account balance, the classification information is rising and falling rate ranges, the baseball term is a win or a lose, and the classification association unit associates a case with the win of the baseball term when the change rate of the stock price or the change rate of the account balance rises according to the classification information, and associates a case with the lose of the baseball term when the change rate of the stock price or the change rate of the account balance falls according to the classification information.

The determination information is information of a change rate of a possessed item stock price or a change rate of an account balance, the classification information is rising and falling rate ranges, the baseball term is a shutout win or a shutout lose, and the classification association unit associates a case with the shutout win when all of an opening price, a low price, a high price, and a closing price of the stock price of the possessed item rise up to a price limit or when all of an opening price, a low price, a high price, and a closing price of the account balance rise higher than a specific range, and associates a case with the shutout lose of the baseball term when all of an opening price, a low price, a high price, and a closing price of the stock price of the possessed item fall down to a price limit or when all of an opening price, a low price, a high price, and a closing price of the account balance fall lower than a specific range.

The determination information is information of a change rate of a possessed item stock price or a change rate of an account balance, the classification information is stock price falling rates at a predetermined trading day or a sum thereof or account balance falling rates or a sum thereof at a predetermined trading day, the baseball term is an allowed run, and the classification association unit associates the information with the allowed run of the baseball term according to the classification information.

The determination information is information of a change rate of a possessed item stock price or a change rate of an account balance, the classification information is stock price falling rates at a predetermined possessing day, a value obtained by dividing a sum of the falling rates by the number of falling days or a value obtained by dividing, or account balance falling rates at a predetermined trading day or a value obtained by dividing a sum of the falling rates by the number of falling days, the baseball term is an earned run average, and the classification association unit associates the information with the earned run average of the baseball term according to the classification information.

Therein the determination information is information of a change rate of a possessed item stock price or a change rate of an account balance, the classification information is a price limit falling rate range or a specific range, the baseball term is an allowed home run, and the classification association unit associates a case with the allowed home run of the baseball term when the change rate of the possessed item stock price falls down to the price limit according to the classification information or the change of the account balance falls equal to or higher than the rising rate range according to the classification information.

Therein the determination information is information of a change rate of a possessed item stock price or a change rate of an account balance, the classification information is rising and falling rate ranges, the baseball term is a draw, and the classification association unit associates a case with the draw of the baseball term when the change rate of the possessed item stock price or the change rate of the account balance is no change according to the classification information.

The classification association unit associates a value obtained by dividing the number of win days by a sum of the number of win days and the number of lose days, with a winning rate.

The determination information is information of a change rate of a possessed item stock price or a change rate of an account balance, the classification information rising and falling rate ranges, the baseball term is a save, and the classification association unit associates a case with the baseball term the save, when an opening price of the possessed item stock price is in the rising range and a closing price is equal to the opening price or rises higher than the opening price or when an opening price of the account balance is in the rising range and a closing price is equal to the opening price or rises higher than the opening price.

The classification association unit associates the number of consecutive saves accumulated backward from the latest day for predetermined trading days with a consecutive save of the baseball term.

The determination information is information of a change rate of a possessed item stock price or a change rate of an account balance, the classification information rising and falling rate ranges, the baseball term is a blown save, and the classification association unit associates a case with the blown save of the baseball term when an opening price of the possessed item stock price is in the rising range and a closing price falls lower than the opening price or when an opening price of the account balance is in the rising range and a closing price falls lower than the opening price.

The determination information is information of a change rate of a possessed item stock price or a change rate of an account balance, the classification information rising and falling rate ranges, the baseball term is an away win, and the classification association unit associates a case with the away win of the baseball term when the stock price rises or the account balance rises at a trading day when a composite price index falls.

The classification association unit associates a value obtained by dividing the number of away win days in a predetermined period by the number of falling days of the composite price index, with an away winning rate.

The invention has an advantage of allowing a stock investor to easily understand characteristics of his own dealing style and pattern through familiar baseball terms.

In addition, the invention has an advantage of regularizing a dealing style and improving an investment style through characteristics associated by baseball terms.

In addition, the invention has an advantage of allowing a beginner investor who does not know well stock information to easily establish and analyze a dealing style.

In addition, the invention has an advantage of analyzing and understanding his dealing pattern or favorite style for a short time since easily understandable baseball terms are utilized.

In addition, the invention has an advantage of allowing also a stock beginner to establish and improve a dealing style with his own analysis capability in addition to traditional analysis methods since it is possible to easily analyze dealing characteristics on the basis of objective indicators.

In addition, the invention has an advantage of helping review and selection of a pattern suitable for each dealing style.

In addition, the invention has an advantage of providing an investment clinic service such as analysis of an investment propensity and problem of an investor or providing of prescription.

### BRIEF DESCRIPTION OF DRAWINGS

FIG. 1 is a diagram illustrating connection relation of a general HTS system.

FIG. 2 is a block diagram illustrating a configuration of a system according to the invention.

FIG. 3 is a flowchart illustrating a characteristic analysis and a providing method according to the invention.

FIGS. 4 to 15 are tables illustrating embodiments of classification information, associated baseball terms, and formulas thereof stored in a term definition unit of the invention.

FIGS. 16 to 18 are diagrams illustrating results analyzed according to the invention, with baseball grounds and associated baseball terms.

### DESCRIPTIONS ON REFERENCE NUMBERS FOR THE MAJOR COMPONENTS IN THE DRAWINGS

10: INFORMATION RECEPTION UNIT

20: INFORMATION EXTRACTION UNIT

30: CLASSIFICATION ASSOCIATION UNIT

40: OUTPUT UNIT

50: TERM DEFINITION UNIT

60: DISPLAY TERMINAL

### DETAILED DESCRIPTION OF THE INVENTION

Hereinafter, a configuration of the invention will be described in detail with reference to embodiments of the invention configuration shown in the accompanying drawings.

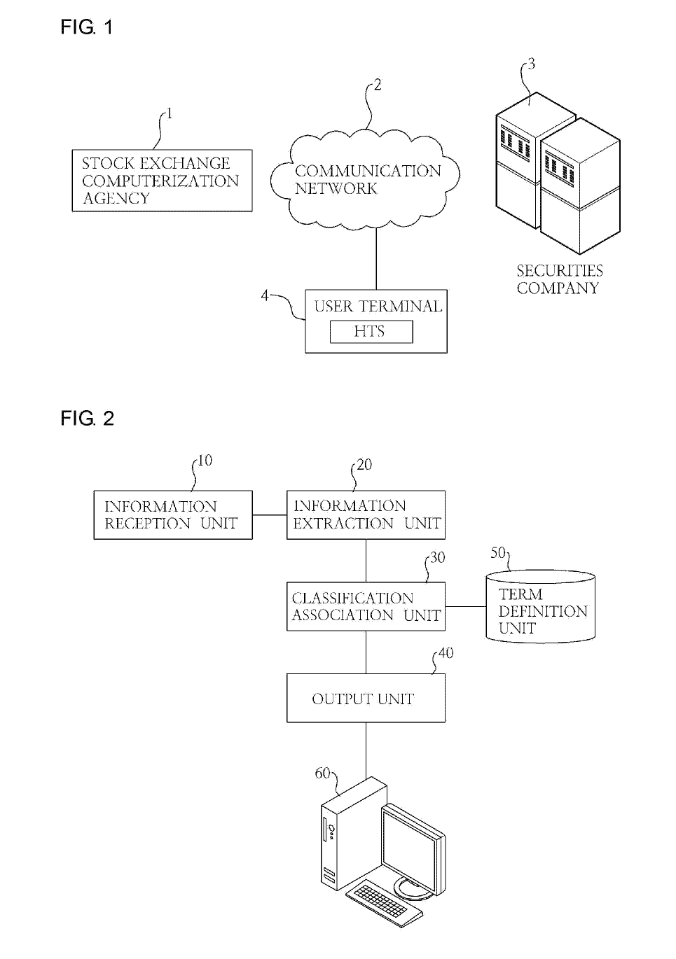

Generally, a system provided from a securities company such as a home trading system (HTS) is used in trading of bonds and currency as well as trading of stocks, futures, and options. FIG. 1 is a diagram illustrating connection relation of a general HTS system. Referring to FIG. 1, various stock related information provided from a stock exchange computerization agency 1 are transmitted to a securities company server 3 through a communication network 2, are transmitted to a user terminal 4 prepared in each of homes, securities company branches, offices through the communication network 2, and are displayed for a user according to operation of an HTS program, and a dealing action such as inputting various trading information can be performed. The securities company server 3 receives and keeps item information, account balance information, and the like of investors.

In spite of such a convenient system, most of various kinds information managed and provided in this system are still contents which are not easily understandable for investors if the investors have not sufficiently learned the contents in advance. In addition, it is general that investors cannot easily recognize their dealing styles, propensities, characteristics selected at the time of obtaining profits, and a wrong pattern at the time of failing.

Meanwhile, it is obvious that the most popular sport in my country is the baseball, and most people know rules and terms of the baseball to some extent. When their own dealing style and propensity information are described in comparison with such a baseball, it is possible to easily and familiarly approach stock beginners and people who have difficulties in various theories. Through this, the investors can increase understanding of stock investment, and have a new viewpoint about statistics.

For this, in the invention, a basic concept is that an investor is considered as a baseball player, who makes marks in a baseball ground such as a stock market according to his dealing. Through this, his stock investment can be analyzed through numerically-expressed scientific statistic means, and thus it is possible to establish a dealing style through scientific stock analysis.

For example, when his dealing is analyzed as a slugger or a speedy batter, it is possible to select and perform a dealing suitable for each situation, and when it is analyzed as a pitcher with a high winning rate, a pitcher with a low earned run average, or a pitcher with little allowed home runs, it is possible to cope with each particular situation. Through such a prediction, it is possible to understand and predict the following characteristics of each stock.
My return rate rises in the morning and falls in the afternoon (strong front and weak rear)
My return rate is strong later
My return rate is the highest at the market opening time most of the time.
My return rate is poor at the market opening time, but is good at the market closing time
My return rate has the great range of fluctuation in a day
My return rate greatly rises in the summer/winter
My return rate frequently rises equal to or higher than the price limit
My return rate is high but falls frequently
My return rate always rises whenever the composite price index rises (correlation with the composite price index)
My return rate falls when the composite price index rises (inverse correlation with composite price index)
My return rate moves together with 00 stocks (correlation with individual items)

In addition, probabilistically the following prediction pattern can be made
Probability that my return rate will be (+) at the market closing time, when my return rate was (+) at the market opening time?
Probability that my return rate will be (+) at the market closing time, when my return rate was (+) at the market opening time and the composite price index was (+)?
Probability that my return rate will be (+) at the market closing time, when my return rate was (+) at the market opening time and the composite price index was (−) at the market closing time?
Probability that my return rate at the market opening time will be higher than the market closing time?
Probability that my return rate will be (+) at the market closing time, when my return rate was (+) at the market opening time and was (−) in the middle of the market?
Probability that my return rate will be (−) at the market closing time, when my return rate was (−) at the market opening time and was (+) on the market?
Probability that my return rate will keep the highest value to the market closing time, when my return rate recorded the highest value on the market?
Probability that my return rate will start with (+) the next day, when my return rate has fallen in recent three days?

The concepts described above have been thought only with vague idea, but according to the invention, this can be defined through corresponding terms, and the corresponding terms most suitable for this are baseball terms. The above-described characteristics defined through the baseball terms play an epochal role of forming insight of classification and division about a market price pattern of a new item, and it is possible to establish a more excellent dealing style. Terms applied to the baseball and various statistic indicators according thereto have very high usability as indicators verified for a long time. The reason is because only verified indicators having meanings as statistic values already through a lot of studies, trials and errors, have been widely used.

Analysis of such dealing patterns allows investors to easily understand them through the baseball terms, stock dealers know that there are characteristics different in dealing methods through this, and it is possible to find patterns and ways suitable for them. A configuration of a system for associating result information about dealings with the baseball terms is as follows.

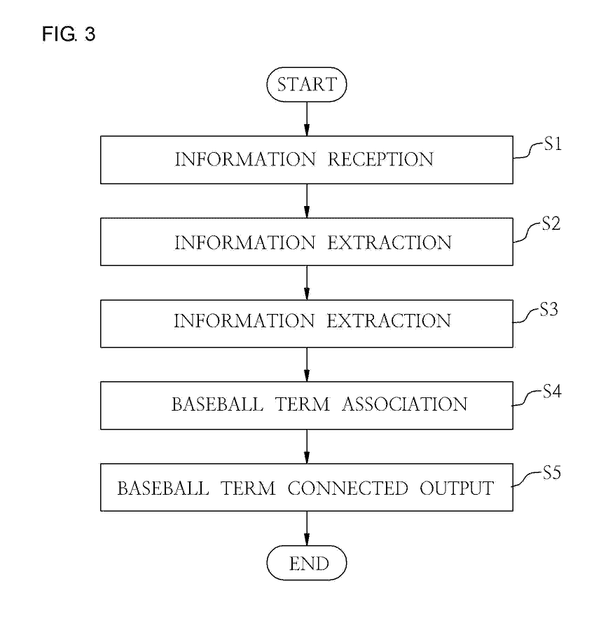

FIG. 2 is a block diagram illustrating a configuration of a system according to the invention, and FIG. 3 is a flowchart illustrating a characteristic analysis and a providing method according to the invention. Referring to FIGS. 2 and 3, the characteristic analysis system has a concept including a general personal computer, a smart phone, a server system, and a wireless terminal, a PDA, a tablet PC, and the like, each of these devices independently plays a role of the characteristic analysis system, or plays a role of the characteristic analysis system by interconnection. That is, one computer terminal is provided therein with an information reception unit 10, an information extraction unit 20, a classification association unit 30, an output unit 40, a term definition unit 50, and a display terminal 60, it is possible to output and display result values by internally extracting and calculating raw data when the computer terminal receives various raw data, or a securities company or a service providing company is provided with the information reception unit 10, the information extracting unit 20, the classification association unit 30, the output unit 40, and the term definition unit 50, only the result values are output from the server to be displayed on another display terminal 60 connected through a communication network, the server takes charge of calculation of the result values, and the user terminal may take charge of displaying of the result values. Modularization and configuration of partial components can be variously applied without limitation according to technical selection and development.

The information reception unit 10 plays a role of receiving trading information, and generally such trading information is received from a stock exchange computerization agency 1 shown in FIG. 1 (S1). The information reception unit 10 receives evaluation information including various kinds of related stock information received by a general HTS, and the information includes market price information such as an opening price, a high price, a low price, a closing price, a rising rate, a falling rate and the like. In addition, the information received herein may be individual corporation items, and may be index items such as KOSPI, KOSDAQ, and futures.

The information extraction unit 20 plays a role of extracting necessary determination information from various kinds of information received through the information reception unit 10, or generating and outputting necessary determination information by calculating and deriving the raw data (S2). For example, the information extraction unit 20 selects and extracts an opening price, a high price, a low price, and a closing price of a specific trading day of a possessed item, from a lot of evaluation information, or calculates and derives a rising rate from the extracted value. Alternatively, it may extract a changed value of an account balance, or may calculate the value to generate a new value. As for various market prices and dealing data of various time zones received by the information reception unit 10, the information extraction unit 20 selectively extracts them, extracts all of them, or edits and calculates them, to provide them for the classification association unit 30.

The classification association unit 30 performs a function of classifying, according to various conditions and formulas, and calculating various kinds of data transmitted from the information extraction unit 20 (S3). In this case, condition formulas and calculation formulas for classification and calculation stored and defined in a separate term definition unit DB are loaded for processing.

The term definition unit 50 stores and provides classification information such as conditions and formulas necessary for the classification association unit 30 and corresponding terms corresponding to the classification information, and the classification association unit 30 determines a corresponding condition and a corresponding defined term of the corresponding item, or on the contrary, determines whether the item belongs to a condition corresponding to a term defined in the term definition unit 50.

The classification information stored in the term definition unit 50 is matched to the corresponding terms corresponding to the classification information, and the classification association unit 30 classifies and calculates whether to correspond to the classification information, and then associates, output, and displays it with the loaded corresponding term.

The classification association unit 30 loads the classification information and the corresponding term from the term definition unit 50, classifies and calculates the conditions transmitted from the information extraction unit 20 according to the classification information, and then matches them with the corresponding terms. In this case, the corresponding terms may be variously set, but in the main embodiments of the invention, the baseball terms are borrowed. The reason is because win, lose, and statistic representation of the baseball are similar to rising, falling, and statistics of stocks and account balances, which are appropriate (S4). The term definition unit 50 stores the baseball terms and the classification information corresponding thereto, such terms and classification information may be modified and added according to the setting by a manager.

Such a matched result value is transmitted from the output unit 40 to the outside, and is finally transmitted through a display device 60 such as a personal terminal and a display of the investor. That is, as will be described later, a specific pattern of dealing and trading is associated with a term which means a specific situation in the baseball, and the term is output with the result value thereof (S5).

Hereinafter, the classification information defined in such a term definition unit 50 and the corresponding terms corresponding thereto, that is, the baseball terms will be described one by one, and such definition, correspondence, and pattern have unique characteristics as themselves.

### EMBODIMENTS

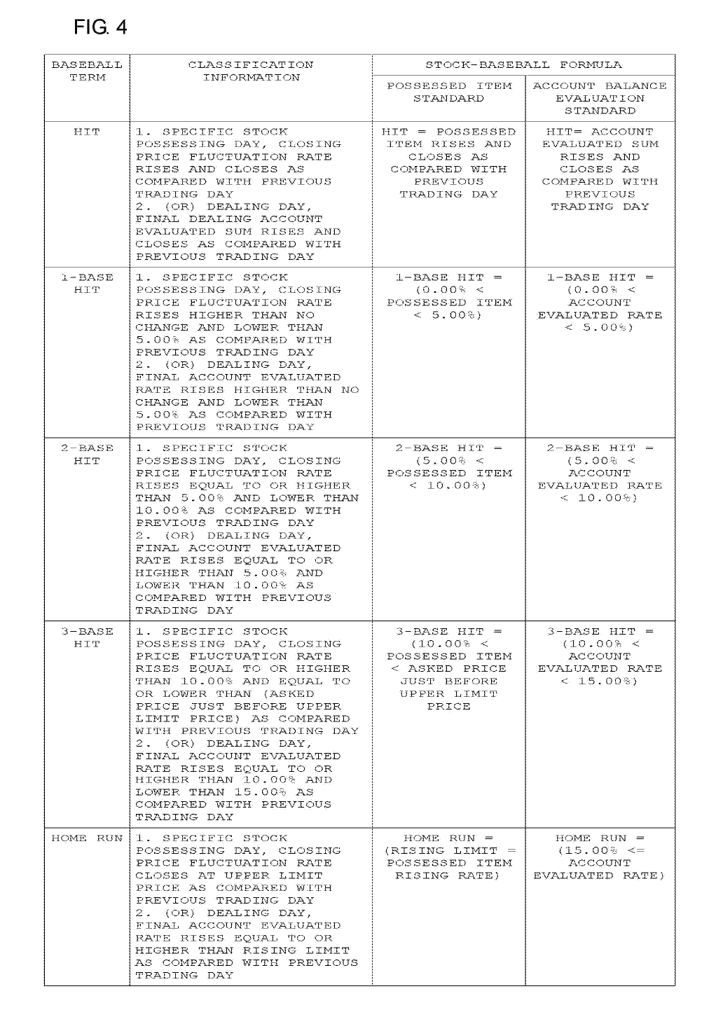

FIGS. 4 to 15 are tables illustrating embodiments of classification information, associated baseball terms, and formulas thereof stored in a term definition unit of the invention.

As divided greatly, such classification may be analyzed to determine a return rate and the like on the basis of items possessed by the investor, or may be analyzed to determine them on the basis of an account balance and an evaluated sum according thereto. The possessed item standard is to analyze possessing one or more days, and the account balance evaluation standard may be used to analyze the day dealing including day trading.

This may be selected, applied to overlap, and utilized according to convenience. In addition, the formula shown in the table of the drawing may include and exclude securities company fees and taxes, and may be individual return rate analysis of possessed items or a return rate of the whole balance. In addition, the account balance evaluation and the like may be performed by sum of money and rate.

Referring to FIG. 4, the baseball term ‘hit’ that is the corresponding term is defined as that the classification information means that a closing price of a possessed item rises on a specific trading day as compared with the previous trading day, and when the determination information corresponds thereto, a result value of ‘hit’ is derived. Alternatively, even when the account balance evaluated sum of the final dealing rises on the dealing day as compared with the previous trading day, the same result may be derived. In the table, a closing price or a closing price fluctuation rate has been exemplified, but the closing price may be modified into an opening price, a low price, a high price, and the like in some cases, and a standard of rising may be a closing price of the previous day and an opening price of the day. The same is applied hereinafter.

For example, when an item A rises and closes by 3%, the determination information also rises 30, and this corresponds to “specific possessing day, the closing price rises as compared with previous trading day’, and this is associated with ‘hit’ and expressed accordingly. When the account evaluated sum rises as compared with the previous trading day, this corresponds to a case of ‘the final dealing account evaluated sum rises as compared with the previous trading day’, and this is associated with ‘hit’ and expressed accordingly.

In addition, as shown in the table, 1-base hit, 2-base hit and 3-base hit are associated with meanings that a closing price (may be modified to an opening price, a high price, a low price, and the like) rises in ranges lower than 5, 10, and 15% and up to an asked price just before the upper limit price, and a home run is associated with rising up to the price limit on the day. Similarly thereto, when the account balance evaluated sum rises as compared with the previous trading day or rises in a specific area on the basis of 5, 10, and 15%, the case may be represented by n-base hit (n=1, 2, or 3), home run, and the like. The home run may be specified to a case of rising equal to or higher than the upper limit price, that is, 15%. That is, when all the possessed items stably reaches the upper limit price or the account balance evaluated sum rises at a specific rising rate, for example, equal to or higher than 15%, this can be associated with the term of home run.

A case of considering a change rate of the possessed item stock price is an example of possessing the possessed item during one day or more, and a case of considering a dealing account evaluated sum may be an example about an evaluated sum in a case of depending on dealing of the day or similarly possessing the possessed item.

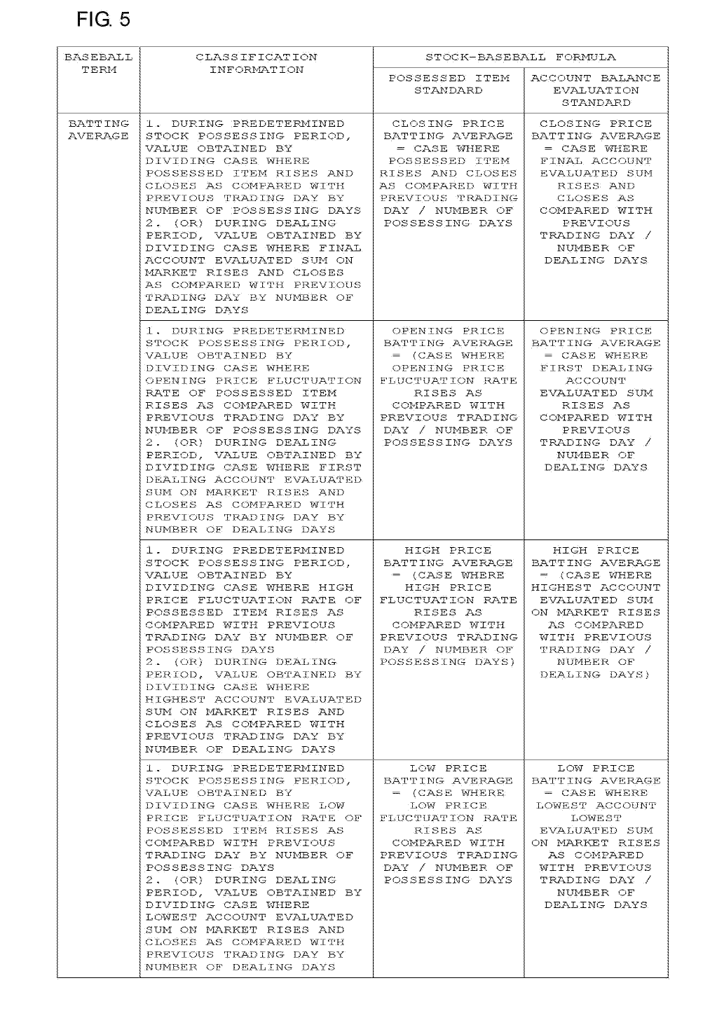

Referring to FIG. 5, the corresponding baseball term ‘batting average’ is a value obtained by dividing the number of days when the possessed item rises and closes as compared with the previous trading day by the number of possessing days, and may be based on an opening price, high price, and low price fluctuation rate. In addition, it may be a value obtained by dividing the number of days when a final, first, highest, or lowest account evaluated sum rises and closes as compared with the previous trading day by the number of possessing or dealing days. These may be associated with a closing price batting average, an opening price batting average, a high price batting average, a low price batting average, and the like.

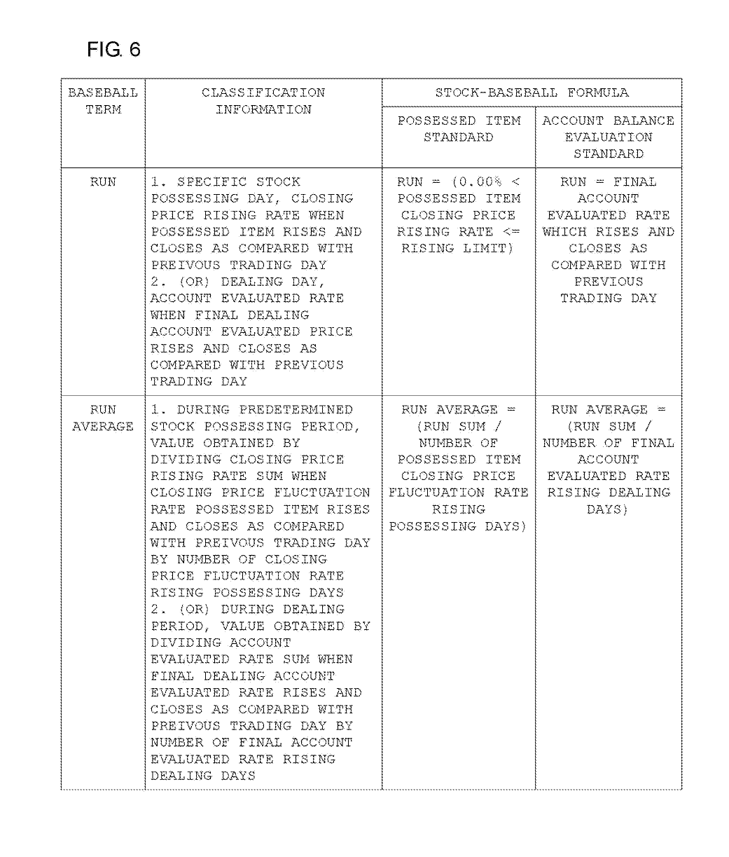

Referring to FIG. 6, the baseball term ‘run’ or ‘run average’ that is the corresponding term means dividing a closing price rising rate when the possessed item rises and closes or the sum thereof by the number of rising possessing days. In addition, it means a value obtained by dividing a final account evaluated rate when the account balance rises and closes as compared with the previous trading day, or a sum thereof by the number of final account evaluated rate rising possessing or dealing days. That is, it means dividing the sum of runs by the number of possessed item closing price fluctuation rate rising possessing days or dividing the sum of runs by the number of final account evaluated rate rising/dealing days.

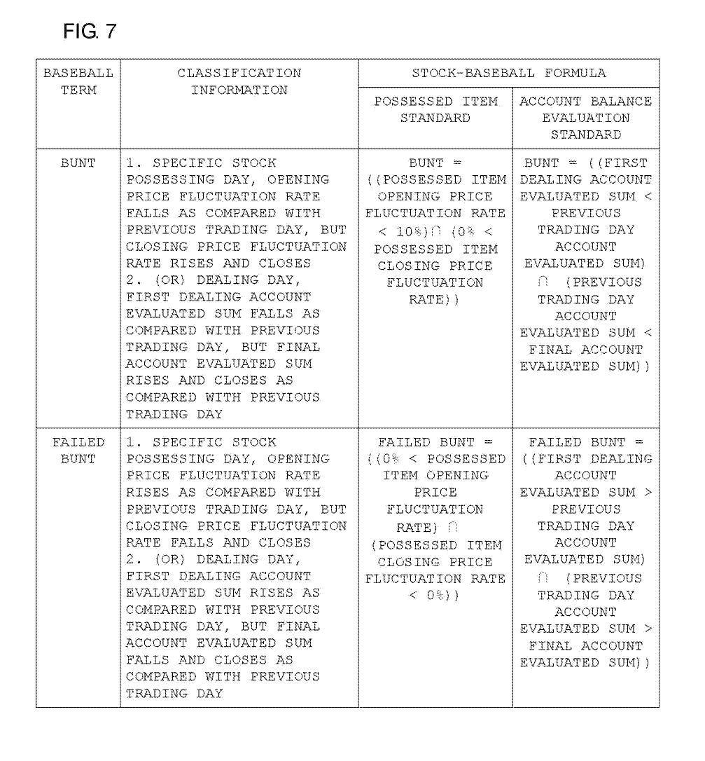

Referring to FIG. 7, the corresponding baseball term ‘bunt’ means that an opening price of the possessed item starts in a state of falling as compared with the previous trading day but a closing price rises and closes higher than no change, and inversely, ‘failed bunt’ means that the opening price starts in a state of rising higher than no change but the closing price falls lower than no change. Similarly, as for the account balance evaluation standard, a case where a first dealing account evaluated sum falls as compared with the previous trading day but a final account evaluated sum rises and closes as compared with the previous trading day is associated with the bunt, and inversely, a case where the first dealing account evaluated sum rises as compared with the previous trading day but the final account evaluated sum falls and closes as compared with the previous trading day is associated with the failed bunt.

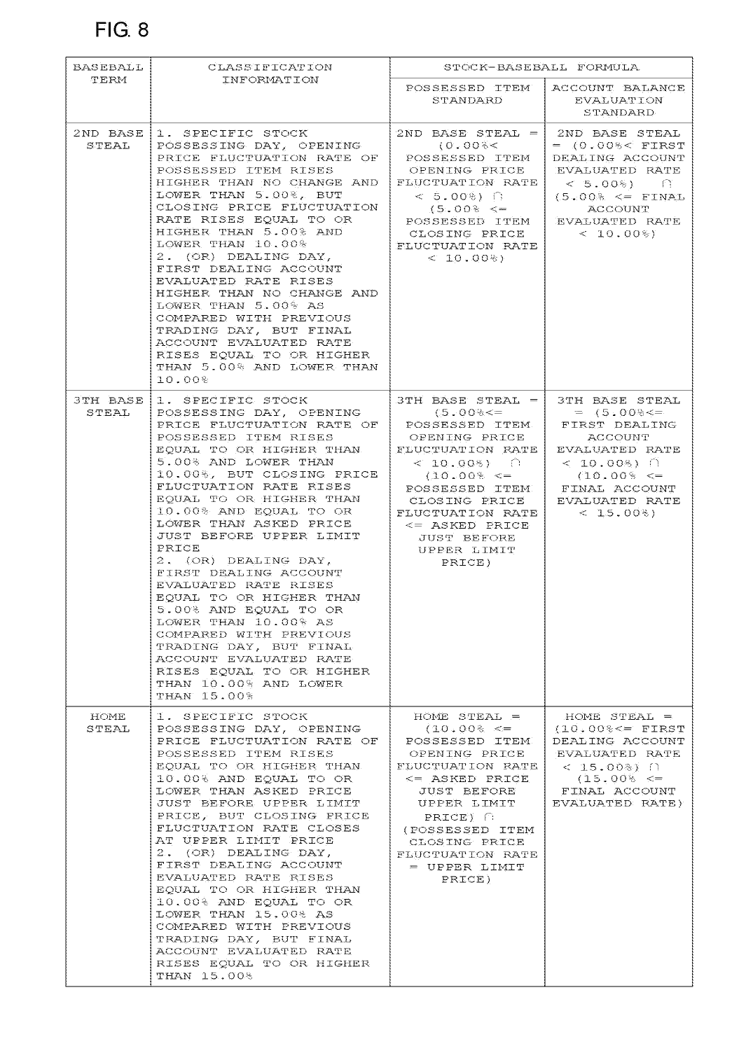

Referring to FIG. 8, the corresponding baseball term ‘steal’ means rising from one area to the other area, ‘2nd base steal’ means that an opening price is in a rising range lower than 5% and a closing price rises and closes in a rising range of 5 to 10%, ‘3th base steal’ means that the opening price starts in rising of 5 to 10% and the closing price rises and closes in a rising range to an asked price just before the upper limit price higher than 10 and lower than 15%, and ‘home steal’ means that the opening price starts in rising to the asked price just before the upper limit price higher than 10 and lower than 15% and the closing price closes at the upper limit price. Similarly, as for the account balance evaluated standard, cases may be associated with the 2nd base steal, the 3th base steal, and the home steal according to the range of the first dealing account evaluated rate and the width of the rising final account evaluated rate. In this case, the including or excluding a threshold value and the rising rate may be adjusted according to selection.

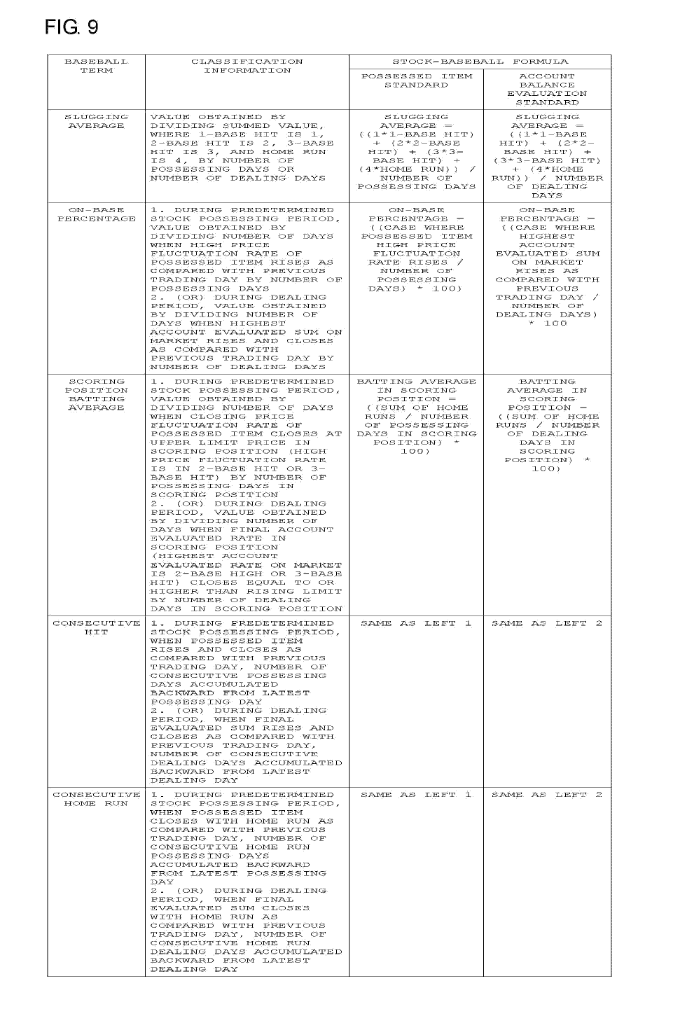

Referring to FIG. 9, the corresponding baseball term ‘slugging average’ means a value obtained by dividing a value obtained by applying weights to the 1, 2, and 3-base hits and home run and summing them by the number of trading days, for example, the weights are 1, 2, 3, and 4. That is, as shown in FIG. 9, the weights are applied in the way of multiplying the 1-base hit by 1 and multiplying the 2-base hit by 2, and a value obtained by multiplying them is divided by the number of dealing or possessing days.

‘On-base percentage’ means a value obtained by dividing the number of days when a high price fluctuation rate during predetermined possessing days rises equal to or higher than no change or a highest account evaluated sum on the market rises as compared with the previous trading day by the number of possessing or dealing days, and ‘scoring position batting average’ means a value obtained by dividing the number of days when a closing price fluctuation rate in a scoring position situation of the 2 or 3-base hit closes to the upper limit price by the number of scoring position situation possessing days. In addition, ‘consecutive hit’ and ‘consecutive home run’ mean the number of consecutive hit days and the number of consecutive home run days accumulated backward from the latest day.

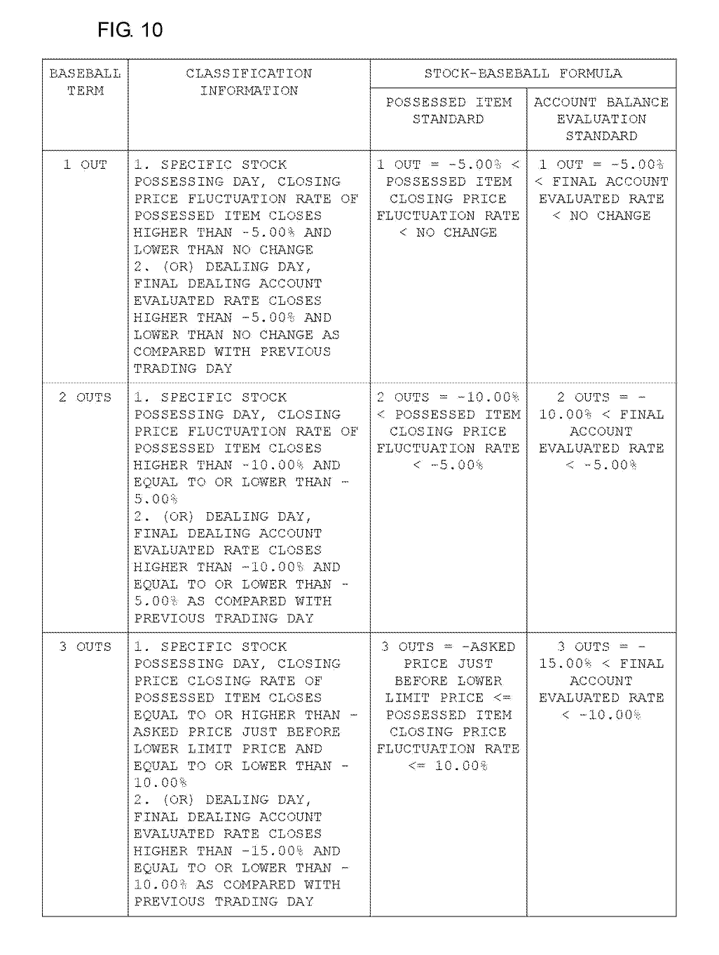

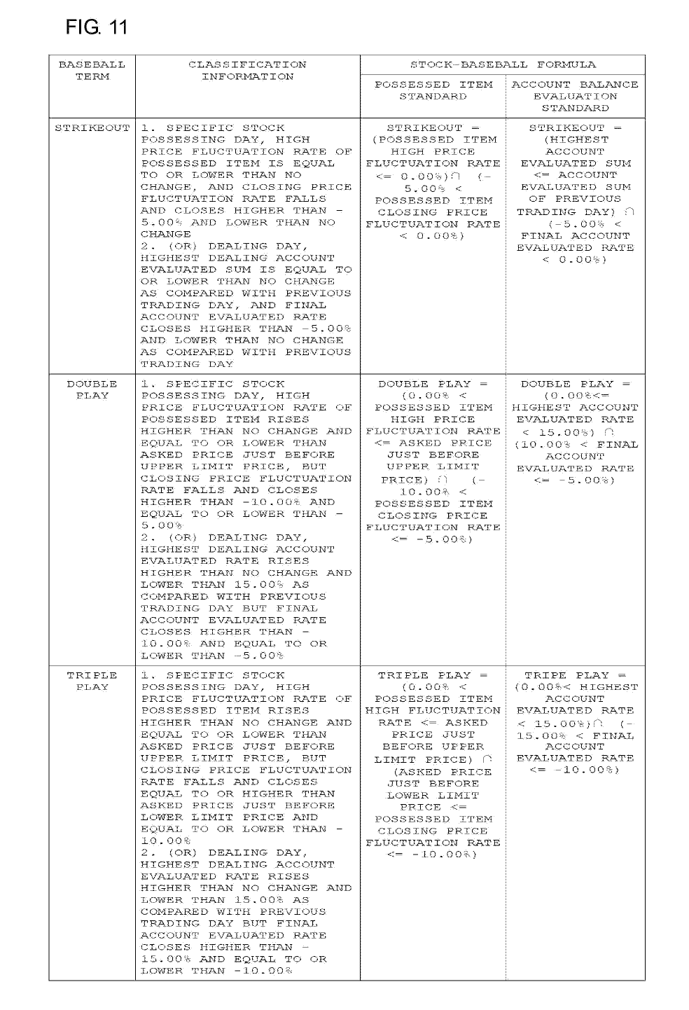

Referring to FIGS. 10 and 11, on the contrary to the hit and base hit, the baseball term ‘out’ that is the corresponding term means falling in a predetermined range, ‘1 out’ means a case of falling and closing to −5% range, ‘2 outs’ means a case of falling and closing to −10% range, and ‘3 outs’ means a case of falling and closing to an asked price just before the lower limit price.

‘Strikeout’ means that a high price is equal to or lower than no change and a closing price falls in a range of −5%, ‘double play’ means that the high price is in a state of rising higher than no change and equal to or lower than an asked price just before the upper limit price but the closing price falls in a range of −5 to −10%, and ‘triple play’ means that the high price rises higher than no change and equal to or lower than the asked price just before the lower limit price but the closing price falls and closes in a range of equal to or higher than the asked price just before the lower limit price and lower than −10%.

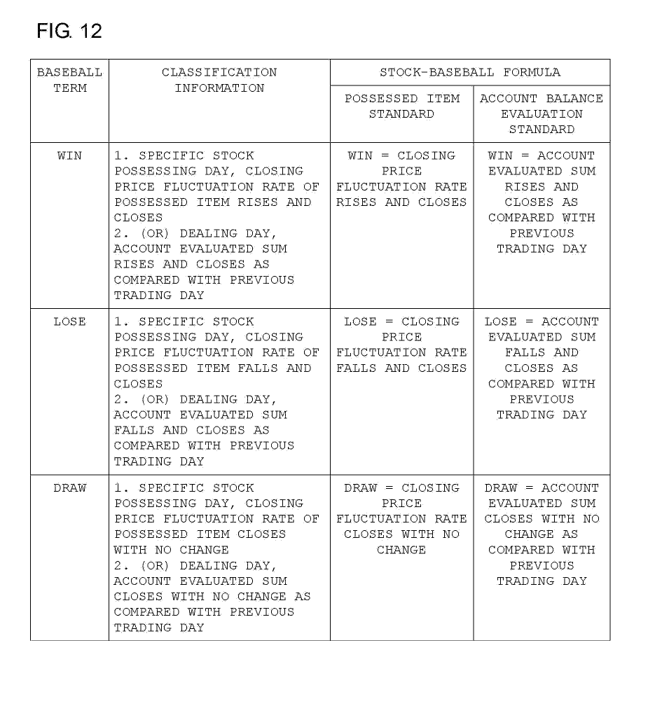

Referring to FIG. 12, the corresponding baseball terms ‘win’, ‘lose’, and ‘draw’ that mean that a closing price or an account evaluated sum rises higher than no change, falls and closes lower than no change, and closes with no change, respectively.

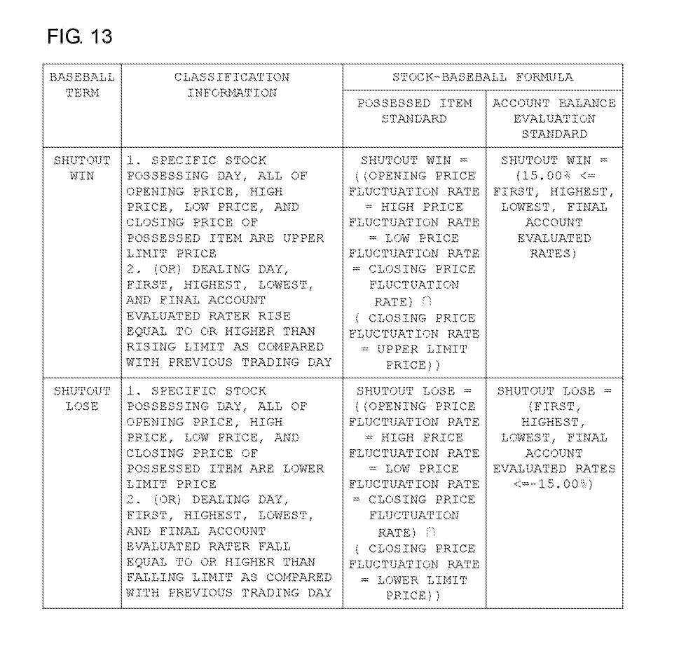

Referring to FIG. 13, the corresponding baseball terms ‘shutout win’ and ‘shutout lose’ mean that an opening price, a low price, a high price, and a closing price are the upper limit price and the lower limit price, respectively. On the basis of the account balance evaluation standard, a case where an opening price, a low price, a high price, and a closing price keep, for example, equal to or higher than 15% or keep equal to or lower than −15% is associated.

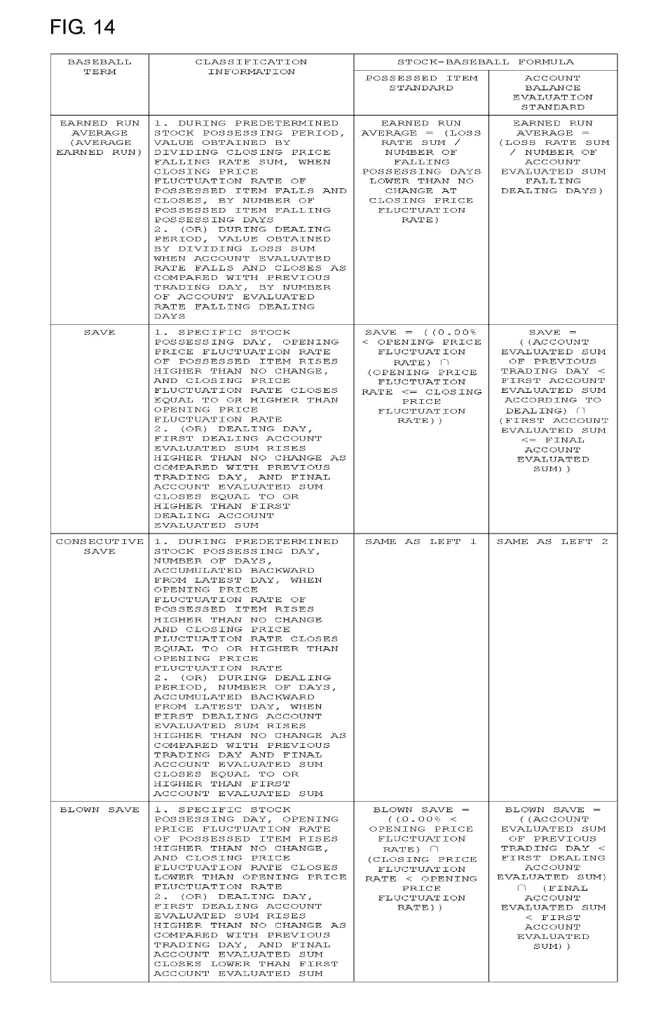

Referring to FIG. 14, the corresponding baseball term ‘an earned run average’ is a value obtained by dividing a closing price falling rate sum when a closing price fluctuation rate falls and closes lower than no change during predetermined possessing days by the number of falling possessing days. ‘Allowed run’ means a closing price falling rate when the closing price fluctuation rate on a specific possessing day falls and closes lower than no change, ‘save’ means that a specific trading day opening price fluctuation rate rises higher than no change and the closing price fluctuation rate rises and closes equal to or higher than the opening price fluctuation rate, and ‘blown save’ means that the closing price fluctuation rate closes lower than the opening fluctuation rate. ‘Consecutive save’ means the number of saves accumulated backward from the latest day, during predetermined trading days. On the account balance evaluation standard, this may be replaced by the account evaluated sum instead of the price and may be associated in the same manner.

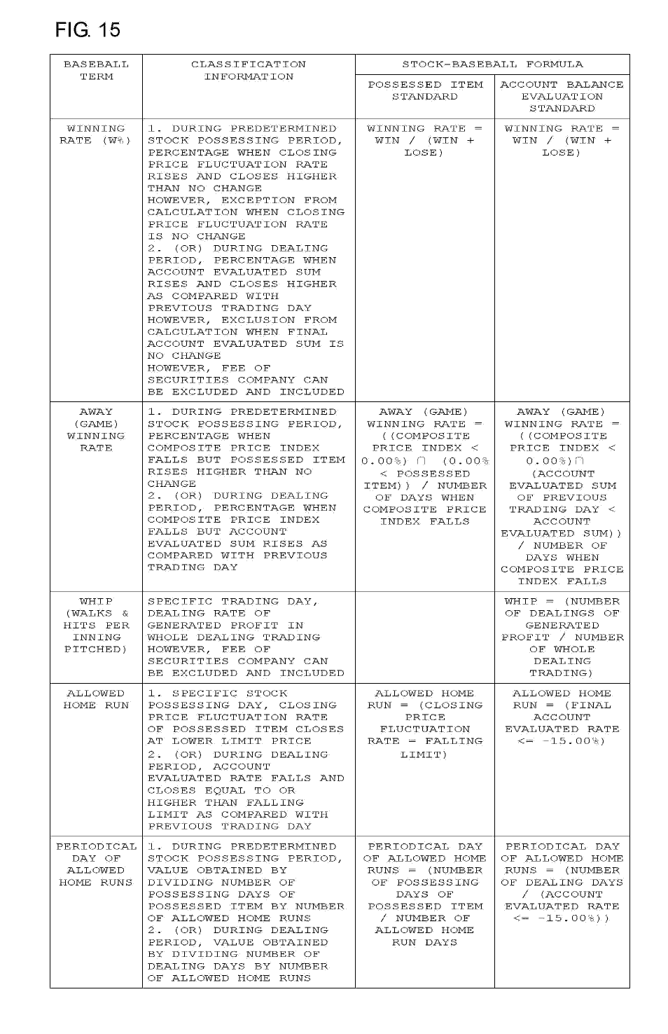

Referring to FIG. 15, the corresponding baseball term ‘winning rate’ is a rate in which a closing price fluctuation rate rises and closes higher than no change during predetermined possessing days excluding a case where the closing price fluctuation rate has no change, in this case, the case of no change may be excluded from calculation, and a securities company fee may be also included or excluded.

‘Away winning rate’ means a rate when the composite price index falls but a closing price of the possessed item rises and closes higher than no change or when an account balance rises. ‘Allowed home run’ means that a closing price fluctuation rate on a specific possessing day closes at the lower limit price or the account balance falls equal or high than −15%.

Meanwhile, in the baseball terms, there are offensive terms, batter terms, defensive terms, pitcher terms, and the like, and thus they may be classified to be used at a proper time by connecting the composite price index. That is, on a day when the composite price index rises, the offensive terms or the batter terms may be used, and on a day when the composite price index falls, the defensive terms or the pitcher terms may be used.

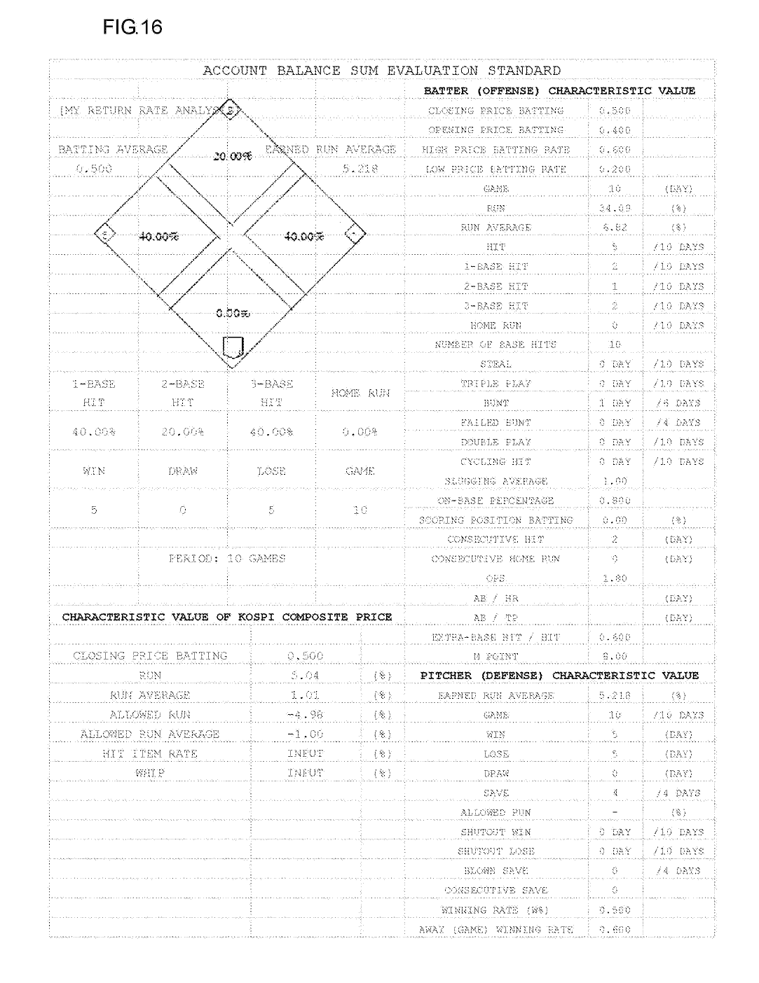

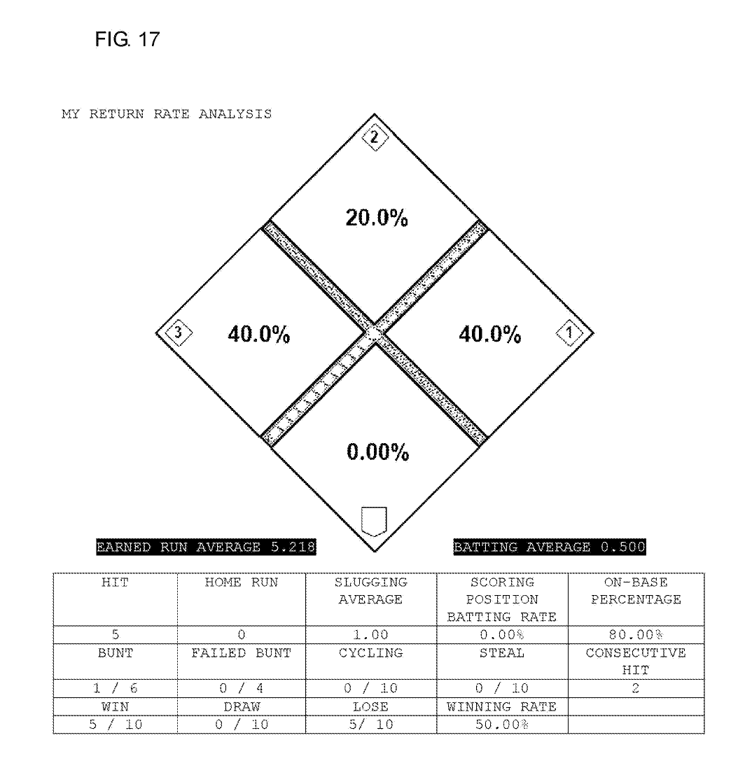

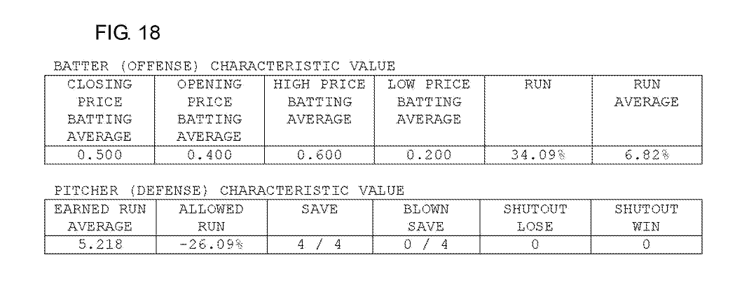

FIGS. 16 to 18 are diagrams illustrating results analyzed according to the invention, with baseball grounds and associated baseball terms. Referring to FIGS. 16 and 18, the result values finally output from the output unit 40 are shown on the display device 60 according to selection of the user in the drawings. According to the drawings, the contents such as the number of hits, 1-base hit rate, 2-base hit rate, 3-base hit rate, home run rate, the number of home runs, slugging average, steal, and double play are represented according to investment pattern of the investor. In addition, as shown in FIG. 18, numerical values about batter characteristic values and numerical values about pitcher characteristic values can be displayed, and thus the investor can easily understand the numerical values together with images coming from the baseball terms. In addition, his own dealing pattern and investment style are understood in association with a baseball player, and may be utilized in the next investment.

That is, there is no way of explaining or specifying his own dealing pattern and investment style merely by only the existing stock terms, and such explaining and specifying are possible according to the invention. In addition, the batting average and the like may be represented by graphs or be expressed by gaming, and it is possible to represent what patterns and styles are suitable for himself and achieve the optimal profits. In addition, it plays a role of helping to establish and select a dealing style through statistics differentiated according to stock trends such as a bullish market, a bearish market, and a steady market. In addition, it is possible to confirm a similar type and similar record of dealing through various kinds of baseball indicators, and to make the pattern of investment consistent. That is, as his dealing pattern analysis result, the investor is analyzed as a speedy batter, a home run batter, a good save pitcher, or the like, and it is possible to grasp his propensity and continuously develop the dealing according thereto.

In the above description, the information reception unit, the information extraction unit, the classification association unit, the output unit, the term definition unit, and the subsidiary configurations thereof that are respective configurations may be configurations separated from each other on hardware, and may be configurations formalized to explain a series of information system according to functions.

By such a system and providing method, it is possible to make an accurate investment analysis, and usability as indicators according to convenience of calculation and recognition is increased. In addition, the indicators are prevented from being distorted, all contents can be easily grasped at once, and usability as a tool of investment decision is increased.

1. A baseball terminology connected investment evaluation and characteristic analysis method comprising:
(1) an information reception step of receiving, by an information reception unit of a user terminal, evaluation information including market price information through a communication network; (2) an information extraction step of outputting, by an information extraction unit, determination information partially extracted from the evaluation information received by the information reception unit or derived by operating; (3) a classification association step of determining and associating, by a classification association unit, a class of the determination information in preset classification information; and (4) an output step of outputting, by an output unit, a result associated by the classification association unit.

2. The baseball terminology connected investment evaluation and characteristic analysis method according to claim 1, further comprising a process of storing, by a term definition unit, the classification information and a term corresponding to the classification information, loading, by the classification association unit, the classification information and the corresponding term stored in the term definition unit, classifying the determination information received from the information extraction unit according to the classification information, and associating the information with the corresponding term.

3. The baseball terminology connected investment evaluation and characteristic analysis method according to claim 2, wherein the corresponding term is a baseball term, and the classification association unit classifies the determination information according to the classification information, and associates the information with the baseball term.

4. The baseball terminology connected investment evaluation and characteristic analysis method according to claim 3, wherein in the output step, a possessed item or dealing pattern thereof is associated with the baseball term to be determined, by converting and outputting the market price change of the possessed item into the baseball term.

5. The baseball terminology connected investment evaluation and characteristic analysis method according to claim 3, wherein in the output step, change of profits and losses of investments or dealing pattern thereof is associated with the baseball term to be determined, by converting and outputting the balance change of the account into the baseball term.

6. A baseball terminology connected investment evaluation and characteristic analysis system comprising:
an information reception unit that receives evaluation information including market price information through a communication network; an information extraction unit that outputs determination information partially extracted from the evaluation information received by the information reception unit or derived by operating; a classification association unit that determines and associates a class of the determination information in preset classification information; and an output unit that outputs a result associated by the classification association unit.

7. The baseball terminology connected investment evaluation and characteristic analysis method according to claim 6, further comprising a term definition unit that stores the classification information and a term corresponding to the classification information, wherein the classification association unit loads the classification information and the corresponding term stored in the term definition unit, classifies the determination information received from the information extraction unit according to the classification information, and associates the information with the corresponding term.

8. The baseball terminology connected investment evaluation and characteristic analysis system according to claim 7, wherein the corresponding term is a baseball term, and the classification association unit classifies the determination information according to the classification information, and associates the information with the baseball term.

9. The baseball terminology connected investment evaluation and characteristic analysis system according to claim 8, wherein the determination information is information of change of a possessed item stock price or change of an account balance, the classification information is a rising range, the baseball term is a hit, and the classification association unit associates a case with the hit of the baseball term when the change of the stock price rises in the rising range according to the classification information or the change of the account balance rises in the rising range according to the classification information.

10. The baseball terminology connected investment evaluation and characteristic analysis system according to claim 8, wherein the determination information is information of a change rate of a possessed item stock price or a change rate of an account balance, the classification information is a price limit rising rate range or a specific range, the baseball term is a home run, and the classification association unit associates a case with the home run of the baseball term when the change rate of the possessed item stock price rises up to the price limit according to the classification information or the change of the account balance rises equal to or higher than the rising rate range according to the classification information.

11. The baseball terminology connected investment evaluation and characteristic analysis system according to claim 8, wherein the determination information is information of a change rate of a possessed item stock price or a change rate of an account balance, the classification information is a part of a rising rate range, the baseball term is an n-base hit (n is one of 1 to 3), and the classification association unit associates a case with the n-base hit of the baseball term when the change rate of the possessed item stock price rises in a partial specific range of the rising rate range according to the classification information or the change of the account balance rises in a partial specific range of the rising rate range according to the classification information.

12. The baseball terminology connected investment evaluation and characteristic analysis system according to claim 8, wherein the determination information is information of a change rate of a possessed item stock price or a change rate of an account balance, the classification information is a value obtained by dividing the number of rising days of the possessed item stock price for predetermined trading days by the number of possessing days or by dividing the rising days of the account balance by the number of possessing or trading days, the baseball term is a batting average, and the classification association unit associates the information with the batting average of the baseball term according to the classification information.

13. The baseball terminology connected investment evaluation and characteristic analysis system according to claim 8, wherein the determination information is information of a change rate of a possessed item stock price or a change rate of an account balance, the classification information is stock price rising rates at a predetermined trading day or a sum thereof or account balance rising rates or a sum thereof at a predetermined trading day, the baseball term is a run, and the classification association unit associates the information with the run of the baseball term according to the classification information.

14. The baseball terminology connected investment evaluation and characteristic analysis system according to claim 8, wherein the determination information is information of a change rate of a possessed item stock price or a change rate of an account balance, the classification information is a value obtained by dividing a sum of stock price rising rates at a predetermined trading day or a sum of account balance rising rates at a predetermined trading day by the number of rising possessing days or the number of rising dealing days, the baseball term is a run average, and the classification association unit associates the information with the run average of the baseball term according to the classification information.

15. The baseball terminology connected investment evaluation and characteristic analysis system according to claim 8, wherein the determination information is information of a change rate of a possessed item stock price or a change rate of an account balance, the classification information is rising and falling rate ranges, the baseball term is a bunt, and the classification association unit associates a case with the bunt of the baseball term when the change rate of the possessed item stock price or the change rate of the account balance was lower than no change at the opening price but rises higher than no change at the closing price according to the classification information.

16. The baseball terminology connected investment evaluation and characteristic analysis system according to claim 8, wherein the determination information is information of a change rate of a possessed item stock price or a change rate of an account balance, the classification information is rising and falling rate ranges, the baseball term is a failed bunt, and the classification association unit associates a case with the failed bunt of the baseball term when the change rate of the possessed item stock price or the change rate of the account balance was higher than no change at the opening price but falls lower than no change at the closing price according to the classification information.

17. The baseball terminology connected investment evaluation and characteristic analysis system according to claim 8, wherein the determination information is information of a change rate of a possessed item stock price or a change rate of an account balance, the classification information is two ranges of a part of a rising rate range, the baseball term is a steal, and the classification association unit associates a case with the steal of the baseball term when the change rate of the possessed item stock price is in a first range at an opening price rising rate and in a second range at a closing price rising rate according to the classification information or the change rate of the account balance is in a first range at the opening price rising rate and rises up to a second range at the closing price rising rate according to the classification information.

18. The baseball terminology connected investment evaluation and characteristic analysis system according to claim 8, wherein the determination information is information of a change rate of a possessed item stock price or a change rate of an account balance, the classification information is a part of a rising rate range, the baseball term is a home steal, and the classification association unit associates a case with the home steal of the baseball term when the change rate of the possessed item stock price is in a first range at an opening price rising rate and rises up to the price limit at a closing price rising rate according to the classification information or the change rate of the account balance is in a first range at the opening price rising rate and rises up to a second range at the closing price rising rate according to the classification information.

19. The baseball terminology connected investment evaluation and characteristic analysis system according to claim 8, wherein the determination information is information of a change rate of a possessed item stock price or a change rate of an account balance, the baseball term is an n-base hit (n is one of 1 to 3) when the classification information is a part of a rising rate range, the baseball term is a home run when the classification information is in a price limit rising range or is equal to or higher than a specific rising rate, and the classification association unit associates a case with the n-base hit when the change rate of the stock price rises in a partial specific range of a rising rate range according to the classification information or when the change rate of the account balance rises in a partial specific range of a rising rate range according to the classification information, associates a case with the home run when the change rate of the stock price rises up to the price limit according to the classification information or when the change rate of the account balance is equal to or higher than a specific rising rate, and associates a value obtained by summing products of weight values corresponding to the n-base hit and the home run and then dividing the sum by the number of possessing days or the number of dealing days, with a slugging average of the baseball term.

20. The baseball terminology connected investment evaluation and characteristic analysis system according to claim 9, wherein the classification association unit associates a value obtained by dividing the number of hit days by the number of possessing days or the number of dealing days with an on-base percentage of the baseball term.

21. The baseball terminology connected investment evaluation and characteristic analysis system according to claim 9, wherein the classification association unit associates the number of days corresponding to consecutive hits accumulated backward from the latest day for predetermined trading days with a consecutive hit of the baseball term.

22. The baseball terminology connected investment evaluation and characteristic analysis system according to claim 10, wherein the classification association unit associates the number of days corresponding to consecutive home runs accumulated backward from the latest day for predetermined trading days with a consecutive home run of the baseball term.

23. The baseball terminology connected investment evaluation and characteristic analysis system according to claim 10, wherein the classification association unit associates a value obtained by dividing the number of days when the stock price of the possessed item belongs to a partial specific range of a rising rate range and then a closing price corresponds to the home run by the number of possessing days when the stock price belongs to the specific range, with a scoring position batting average of the baseball term, or associates a value obtained by dividing the number of days when the account balance belongs to a partial specific range of a rising rate range and then a closing price corresponds to the home run by the number of trading days when the account balance belongs to the specific range, with a scoring position batting average of the baseball term.

24. The baseball terminology connected investment evaluation and characteristic analysis system according to claim 8, wherein the determination information is information of a change rate of a possessed item stock price or a change rate of an account balance, the classification information is a falling range, the baseball term is an out, and the classification association unit associates a case with the out of the baseball term when the change of the stock price or the change of the account balance falls in the falling range according to the classification information.

25. The baseball terminology connected investment evaluation and characteristic analysis system according to claim 8, wherein the determination information is information of a change rate of a possessed item stock price or a change rate of an account balance, the classification information is a part of a falling rate range, the baseball term is a strikeout, a double play, or a triple play, and the classification association unit associates a case with the strikeout, the double play, or the triple play of the baseball term when the change rate of the stock price or the change rate of the account balance falls in a partial specific range of a falling rate range according to the classification information.

26. The baseball terminology connected investment evaluation and characteristic analysis system according to claim 8, wherein the determination information is information of a change rate of a possessed item stock price or a change rate of an account balance, the classification information is rising and falling rate ranges, the baseball term is a win or a lose, and the classification association unit associates a case with the win of the baseball term when the change rate of the stock price or the change rate of the account balance rises according to the classification information, and associates a case with the lose of the baseball term when the change rate of the stock price or the change rate of the account balance falls according to the classification information.

27. The baseball terminology connected investment evaluation and characteristic analysis system according to claim 8, wherein the determination information is information of a change rate of a possessed item stock price or a change rate of an account balance, the classification information is rising and falling rate ranges, the baseball term is a shutout win or a shutout lose, and the classification association unit associates a case with the shutout win when all of an opening price, a low price, a high price, and a closing price of the stock price of the possessed item rise up to a price limit or when all of an opening price, a low price, a high price, and a closing price of the account balance rise higher than a specific range, and associates a case with the shutout lose of the baseball term when all of an opening price, a low price, a high price, and a closing price of the stock price of the possessed item fall down to a price limit or when all of an opening price, a low price, a high price, and a closing price of the account balance fall lower than a specific range.

28. The baseball terminology connected investment evaluation and characteristic analysis system according to claim 8, wherein the determination information is information of a change rate of a possessed item stock price or a change rate of an account balance, the classification information is stock price falling rates at a predetermined trading day or a sum thereof or account balance falling rates or a sum thereof at a predetermined trading day, the baseball term is an allowed run, and the classification association unit associates the information with the allowed run of the baseball term according to the classification information.

29. The baseball terminology connected investment evaluation and characteristic analysis system according to claim 28, wherein the determination information is information of a change rate of a possessed item stock price or a change rate of an account balance, the classification information is stock price falling rates at a predetermined possessing day, a value obtained by dividing a sum of the falling rates by the number of falling days or a value obtained by dividing, or account balance falling rates at a predetermined trading day or a value obtained by dividing a sum of the falling rates by the number of falling days, the baseball term is an earned run average, and the classification association unit associates the information with the earned run average of the baseball term according to the classification information.

30. The baseball terminology connected investment evaluation and characteristic analysis system according to claim 8, wherein the determination information is information of a change rate of a possessed item stock price or a change rate of an account balance, the classification information is a price limit falling rate range or a specific range, the baseball term is an allowed home run, and the classification association unit associates a case with the allowed home run of the baseball term when the change rate of the possessed item stock price falls down to the price limit according to the classification information or the change of the account balance falls equal to or higher than the rising rate range according to the classification information.

31. The baseball terminology connected investment evaluation and characteristic analysis system according to claim 8, wherein the determination information is information of a change rate of a possessed item stock price or a change rate of an account balance, the classification information is rising and falling rate ranges, the baseball term is a draw, and the classification association unit associates a case with the draw of the baseball term when the change rate of the possessed item stock price or the change rate of the account balance is no change according to the classification information.

32. The baseball terminology connected investment evaluation and characteristic analysis system according to claim 26, wherein the classification association unit associates a value obtained by dividing the number of win days by a sum of the number of win days and the number of lose days, with a winning rate.

33. The baseball terminology connected investment evaluation and characteristic analysis system according to claim 8, wherein the determination information is information of a change rate of a possessed item stock price or a change rate of an account balance, the classification information rising and falling rate ranges, the baseball term is a save, and the classification association unit associates a case with the save of the baseball term when an opening price of the possessed item stock price is in the rising range and a closing price is equal to the opening price or rises higher than the opening price or when an opening price of the account balance is in the rising range and a closing price is equal to the opening price or rises higher than the opening price.

34. The baseball terminology connected investment evaluation and characteristic analysis system according to claim 33, wherein the classification association unit associates the number of consecutive saves accumulated backward from the latest day for predetermined trading days with a consecutive save of the baseball term.

35. The baseball terminology connected investment evaluation and characteristic analysis system according to claim 8, wherein the determination information is information of a change rate of a possessed item stock price or a change rate of an account balance, the classification information rising and falling rate ranges, the baseball term is a blown save, and the classification association unit associates a case with the blown save of the baseball term when an opening price of the possessed item stock price is in the rising range and a closing price falls lower than the opening price or when an opening price of the account balance is in the rising range and a closing price falls lower than the opening price.

36. The baseball terminology connected investment evaluation and characteristic analysis system according to claim 8, wherein the determination information is information of a change rate of a possessed item stock price or a change rate of an account balance, the classification information rising and falling rate ranges, the baseball term is an away win, and the classification association unit associates a case with the away win of the baseball term when the stock price rises or the account balance rises at a trading day when a composite price index falls.

37. The baseball terminology connected investment evaluation and characteristic analysis system according to claim 36, wherein the classification association unit associates a value obtained by dividing the number of away win days in a predetermined period by the number of falling days of the composite price index, with an away winning rate.
